(19) United States
(12) Patent Application Publication
(10) Pub. No.: US 2014/0127546 A1
(43) Pub. Date: May 8, 2014

(54) SEPARATOR WITH ADDITIVE FOR IMPROVING THE COATING QUALITY AND REDUCING AGGLOMERATES IN A CERAMIC COMPOSITE

(71) Applicants: Matthias Pascaly, Frankfurt (DE); Rolf-Walter Terwonne, Marl (DE); Christian Hying, Rhede (DE); Henrik Hahn, Essen (DE)

(72) Inventors: Matthias Pascaly, Frankfurt (DE); Rolf-Walter Terwonne, Marl (DE); Christian Hying, Rhede (DE); Henrik Hahn, Essen (DE)

(73) Assignee: EVONIK LITARION GmbH, Kamenz (DE)

(21) Appl. No.: 14/112,823

(22) PCT Filed: Feb. 27, 2012
(86) PCT No.: PCT/EP2012/053278

§ 371 Date: Jan. 3, 2014

(30) Foreign Application Priority Data
Apr. 20, 2011 (DE) 10 2011 007 750.2

(51) Int. Cl. H01M 2/16; H01M 2/14

(52) U.S. Cl. CPC H01M 2/1686; H01M 2/145
USPC 429/144; 427/58

(57) ABSTRACT

The invention relates to a separator which has a porous coating which is not electrically conductive and is composed of oxide particles which are adhesively bonded to one another and to the substrate by means of an inorganic adhesive and comprise at least one oxide selected from among Al₂O₃ and SiO₂ on a substrate and in the interstices of the substrate which has fibres composed of a material which is not electrically conductive, characterized in that at least one sugar is present in the ceramic coating.

The present invention relates to a separator with additive for improving the coating quality, a process for producing such a separator and also an electrochemical cell comprising such a separator.

A separator is conventionally a thin, porous, electrically insulating material having a high ion permeability, good mechanical strength and long-term stability towards the chemicals and solvents used in the system, e.g. electrolytes of the electrochemical cell. Its purpose is to completely insulate the cathode electronically from the anode in electrochemical cells. In addition, it has to be permanently elastic and follow the movements in the system, e.g. in the electrode packet during charging and discharging.

The separator critically determines the life of the electrochemical cell. The development of rechargeable electrochemical cells or batteries is therefore influenced by the development of suitable separator materials. General information about electric separators and batteries may be found, for example, in J. O. Besenhard in “Handbook of Battery Materials” (VCH-Verlag, Weinheim 1999).

The production of ceramic coatings on a nonwoven, for example a polyethylene terephthalate (PET) nonwoven, is carried out in a roll-to-roll process. To produce the coatings, a ceramic slip containing aluminium oxide, silicon dioxide and silanes dispersed in water is continuously applied to the nonwoven. For various reasons, the coating can have defects which show up as light-coloured spots in the coated product and can be detected by means of video monitoring. The defects in the coating are due, firstly, to not all particles being comminuted to a size of less than 2 μm when dispersing the ceramic. Such excessively large particles show up in the end product as spots, as a person skilled in the art will know. In addition, occasional stirring-in of air both during dispersion and also during the coating process on the respective coating rollers can lead to undesirable spots. Impurities which are not compatible with the ceramic slip, e.g. silicones, fats or oils, can also cause spots. Such defects in the coating are known to those skilled in the art as “wetting defects”.

The defects in the coating and wetting defects make it difficult to employ the separator materials in high-performance battery systems since they make control of the porosity of the separator, on which the internal resistance in turn depends, difficult. In addition, they interfere in the wettability of the separator with electrolytes, so that unwetted dead zones occur.

It was therefore an object of the present invention to provide a separator which has fewer defects in the coating than separators of the prior art.

It has surprisingly been found that a separator which has a porous coating which is not electrically conductive and is composed of oxide particles which are adhesively bonded to one another and to the substrate by means of an inorganic adhesive and comprise at least one oxide selected from among Al₂O₃ and SiO₂ on a substrate and in the interstices of the fibre-containing substrate, where at least one sugar is present in the ceramic coating, has significantly fewer defects in the coating.

The present invention therefore provides a separator which has a porous coating which is not electrically conductive and is composed of oxide particles which are adhesively bonded to one another and to the substrate by means of an inorganic adhesive and comprise at least one oxide selected from among Al₂O₃ and SiO₂ on a substrate and in the interstices of the substrate which has fibres composed of a material which is not electrically conductive, characterized in that at least one sugar is present in the ceramic coating.

The present invention likewise provides a process for producing a separator according to the invention, characterized in that a substrate comprising fibres composed of a material which is not electrically conductive and has interstices between the fibres is provided with a ceramic coating, for which purpose a suspension is applied on and in the substrate and this is solidified on and in the substrate by means of heating at least once, where the suspension comprises a sol containing oxide particles selected from among the oxides of the elements Al and Si dispersed in the sol, at least one silane, at least one dispersion medium and at least one sugar.

The present invention also provides for the use of a separator according to the invention as separator in batteries and also lithium ion batteries which have a separator according to the invention and traction systems comprising such batteries.

For the purposes of the invention, sugars are organic compounds having a hemiacetal/hemiketal-forming carbonyl group and a plurality of hydroxy groups in the molecule, which means polyhydroxyaldehydes (aldoses), polyhydroxyketones (ketoses), both monosaccharides and polysaccharides, linear or cyclic.

The separator of the invention has the advantage that it has a smaller number of defects per unit area compared to commercial ceramic separators. For the present purposes, defects are defects in the coating. The average frequency of defects in the separator of the invention is typically only about half that of separators according to the prior art. In addition, the surface of the separator of the invention is particularly smooth.

In an electrochemical cell, the separator of the invention displays a significantly better cycling behaviour. This is a further advantage of the invention.

In the following, the separator of the invention and the process of the invention will be described by way of example.

The separator of the invention is characterized in that at least one sugar is present in the ceramic coating.

Preference is given to cyclic sugars comprising from 6 to 8 glucose units, preferably cyclodextrin, being present as sugar in the separator of the invention.

The separator of the invention preferably has, on at least one side, a number of defects of not more than 4.5 m².

The separator of the invention preferably comprises oxide particles which have an average particle size of less than 0.5 times, preferably less than 0.2 times and more preferably less than 0.1 times, the thickness of the separator.

The average particles size of the oxide particles can be determined by means of small-angle laser light scattering in the production of the separator. The particle size of the polymer particles and the oxide particles in the finished separator can be determined by examination by means of a scanning electron microscope.

The separators of the invention preferably have substrates which are flexible and preferably have a thickness of less than 50 μm. The flexibility of the substrate ensures that the separator of the invention can also be flexible. Such flexible separators can then be used, in particular, for producing wound cells.

The substrates have interstices. In particular, the substrates have interstices which represent pores, i.e. interstices which make it possible for material to pass in a direct or indirect line from one side of the substrate to the other side.

The thickness of the substrate has a great influence on the properties of the separator since firstly the flexibility and also the surface resistance of the electrolyte-impregnated separator is dependent on the thickness of the substrate. The separator of the invention therefore preferably has substrates which have a thickness of less than 30 μm, particularly preferably less than 20 μm. To be able to achieve a sufficiently high performance of the batteries, in particular in the case of lithium ion batteries, it has been found to be advantageous for the separator of the invention to have a substrate which preferably has a porosity of greater than 40%, preferably from 50 to 97%, particularly preferably from 60 to 90% and very particularly preferably from 70 to 90%. The porosity is defined here as the volume of the substrate (100%) minus the volume of the fibres of the substrate, i.e. the proportion of the volume of the substrate which is not filled by material. The volume of the substrate can be calculated from the dimensions of the substrate. The volume of the fibres is derived from the measured weight of the nonwoven in question and the thickness of the fibres. In a particularly preferred embodiment of the separator of the invention, the substrate is a nonwoven having an average pore width of from 5 to 500 μm, preferably from 10 to 200 μm.

The substrate can comprise woven or unwoven fibres of polymers, natural fibres, carbon fibres, glass fibres or ceramic fibres as fibres which are not electrically conductive. The substrate preferably comprises woven or unwoven polymer fibres. The substrate particularly preferably comprises a woven polymer fabric or nonwoven or is such a woven fabric or nonwoven. As polymer fibres, the substrate preferably comprises fibres which are not electrically conductive and are composed of polymers which are preferably selected from among polyacrylonitrile (PAN), polyamide, (PA), polyester such as polyethylene terephthalate (PET) and polyolefin (PO) such as polypropylene (PP) or polyethylene (PE) or mixtures of such polyolefins. If the porous substrate comprises polymer fibres, it is also possible to use polymer fibres other than those mentioned above as long as they both have the thermal stability necessary for production of the separators and are stable under the operating conditions in an electrochemical cell, preferably in a lithium ion battery. In a preferred embodiment, the separator of the invention comprises polymer fibres which have a softening point of greater than 100° C. and a melting point of greater than 110° C.

The substrate can comprise fibres and/or filaments having a diameter of from 0.1 to 150 μm, preferably from 1 to 20 μm, and/or threads having a diameter of from 1.5 to 15 μm, preferably from 2.5 to 7.5 μm. If the substrate comprises polymer fibres, these preferably have a diameter of from 0.1 to 10 μm, particularly preferably from 1 to 5 μm. Particularly preferred nonwovens, in particular polymer nonwovents, have a weight per unit area of less than 20 g/m², preferably from 5 to 15 g/m². A particularly low thickness and high flexibility of the substrate are ensured in this way.

The separator of the invention particularly preferably has a polymer nonwoven having a thickness of less than 30 μm, preferably a thickness of from 10 to 20 μm, as substrate. A very homogeneous pore radius distribution in the nonwoven is particularly important for use in a separator according to the invention. A very homogeneous pore radius distribution in the nonwoven leads, in combination with optimally matched oxide particles of a particular size, to an optimized porosity of the separator of the invention.

The inorganic adhesive in the separator of the invention is preferably selected from among oxides of the elements Al, Si and Zr. The inorganic adhesive can comprise particles having an average particle size of less than 20 nm and have been produced by means of a particulate sol or have an inorganic network of the oxides which has been produced by means of a polymeric sol.

It can be advantageous for the separator of the invention to additionally have an inorganic, silicon-comprising network, with the silicon of the network being bound via oxygen atoms to the oxides of the inorganic coating and via an organic radical to the substrate comprising polymer fibres. Such a network can, for example, be obtained when a bonding agent, e.g. based on silane, is used in the production of the separator and this bonding agent is subjected to the thermal treatment usual in the production of the separator.

The porous, electrically insulating coating present on and in the substrate particularly preferably has an average pore size in the range from 50 nm to 5 μm and preferably from 100 to 1000 nm.

The stability of the separator towards the action of heat and thus also the safety of the separator are critically determined by the oxide particles of the coating and the small number of defects in the coating. In addition, the pore size is determined essentially by the coating or the particle size of the particles present in the coating and can thus be adjusted relatively finely.

The separators of the invention can preferably be bent without damage to any radius down to 100 mm, preferably to a radius of from 100 mm down to 50 mm and very particularly preferably to a radius of from 50 mm down to 0.5 mm. In addition, the separators of the invention preferably have a tear strength of at least 1 N/cm, preferably at least 3 N/cm and very particularly preferably greater than 5 N/cm. The high tear strength and the good bendability of the separator of the invention has the advantage that changes in the geometries of the electrodes which occur during charging and discharging of a battery can be followed by the separator without the latter being damaged. The bendability also has the advantage that commercially standardized wound cells can be produced using this separator. In these cells, the electrodes/separator layers having a standardized size are wound up together in the manner of a spiral and provided with contacts.

The separator of the invention preferably has a porosity of from 30 to 80%. The porosity relates here to the accessible, i.e. open, pores. The porosity can be determined by means of the known method of mercury porosimetry (using a method based on DIN 66 133) or can be calculated from the volume and the density of the starting materials used if it is assumed that only open pores are present.

The separators of the invention preferably have a thickness of less than 50 μm, preferably less than 40 μm, particularly preferably a thickness of from 5 to 30 μm and very particularly preferably a thickness of from 10 to 20 μm. The thickness of the separator has a strong influence on the properties of the separator since firstly the flexibility and also the surface resistance of the electrolyte-impregnated separator is dependent on the thickness of the separator. As a result of the low thickness, a particularly low electrical resistance of the separator is achieved when the separator is used together with an electrolyte. The separator itself naturally has a very high electrical resistance since it itself has to have insulating properties. In addition, thinner separators allow an increased packing density in a battery stack, so that a greater quantity of energy can be stored in the same volume.

Due to its configuration according to the invention, the separator of the present invention is highly suitable for electrochemical cells having a high capacity and a high energy density. In particular, the separator of the invention is suitable for electrochemical cells which are based on the transfer of alkali metal ions and/or alkaline earth metal ions, e.g. lithium metal batteries and lithium ion batteries. It is therefore advantageous for these separators also to have the protective measures specific to these uses, e.g. the interruption property and short circuit property with a high short circuit temperature. For the present purposes, the interruption property or shutdown is a measure in which low-melting materials selected for particular operating temperatures, for example thermoplastic polymers, can be incorporated into the separator. In the case of the operating temperature rising as a result of malfunctions such as overloading, external or internal short circuits, low-melting materials can melt and block the pores of the separator. The ion flow through the separator is thus partially or completely blocked and a further increase in the temperature is prevented. Short circuit property or meltdown means that the separator melts completely at a short circuit temperature. This can result in contact between large areas of the electrodes of an electrochemical cell and a short circuit. A very high short circuit temperature is desirable for safe operation of an electrochemical cell having a high capacity and energy density. Here, the separator of the invention has a distinct advantage because the ceramic material which adheres to the porous substrate in the separation of the present invention has a melting point which is far above the safety-relevant temperature range for electrochemical cells. The separator of the present invention therefore displays excellent safety.

Polymer separators bring, for example, the safety presently required for lithium batteries by preventing any mass transfer through the electrolyte above a particular temperature (the shutdown temperature which is about 120° C.). This is effected by the pore microstructure of the separator breaking down at this temperature and all pores being closed. As a result of ions no longer being able to be transported, the hazardous reaction which can lead to an explosion ceases. However, if the cell is heated further as a result of external circumstances, the meltdown temperature is exceeded at about 150-180° C. Above this temperature, the separator melts and contracts. Direct contact between the two electrodes therefore occurs at many places in the battery cell and a large-area internal short circuit results. This leads to an uncontrolled reaction which frequently ends in explosion of the cell, or the pressure generated is released via an overpressure valve (a bursting disc), frequently associated with fire.

For the purposes of the present invention, the flexible, porous substrate of the separator can comprise polymer fibres. In this hybrid separator, which comprises essentially an inorganic coating and polymeric substrate material, shutdown occurs when the polymer microstructure of the substrate material melts as a result of the high temperature and penetrates into the pores of the inorganic coating and thereby closes these pores. On the other hand, meltdown does not occur in the case of the separator of the invention. The separator of the invention thus meets the requirements for safety shutdown of the battery cells demanded by various battery manufacturers. The inorganic particles ensure that meltdown can never occur. It is thus ensured that there are no operating conditions in which a large-area short circuit can occur.

The separator of the invention is also very safe in the event of an internal short circuit which could, for example, be caused by an accident. Should, for example, a nail penetrate through a battery, the following occurs, depending on the separator: the polymer separator would melt at the point of penetration (a short circuit current flows through the nail and heats this) and contracts. The short circuit site becomes ever larger as a result and the reaction goes out of control. On the other hand, in the case of the embodiment with the hybrid separator of the invention, the polymeric substrate material melts but the inorganic material of the coating does not. The reaction in the interior of the battery cell is therefore greatly moderated after such an accident. Such a battery is therefore significantly safer than a battery equipped with a polymer separator. This is of particular importance in mobile applications.

The separator of the invention can, for example, be obtained by the inventive process described below. This process is based on the process for producing separators or membranes as is described in principle in WO 99/15262. This document is expressly incorporated by reference.

The process of the invention for producing the separator claimed is characterized in that a substrate which comprises fibres of a material which is not electrically conductive and has interstices between the fibres is provided with a ceramic coating, for which purpose a suspension is applied on and in the substrate and this is solidified on and in the substrate by heating at least once, where the suspension comprises a sol containing oxide particles selected from among the oxides of the elements Al and Si dispersed in the sol, at least one silane, at least one dispersion medium and at least one sugar.

As dispersion media, it is possible to use media which are disclosed, for example, in the documents WO 99/15262 or WO 2007/028662. These are not influenced by the addition of sugar.

In the process of the invention, a cyclic and/or acyclic sugar which preferably has from 6 to 8 glucose units, particularly preferably cyclodextrin, or a mixture of these sugars can advantageously be used. Cyclodextrin can be hydrophobicized by alkylation or acylation. As a result, the sugar can more readily mix with the hydrophobic constituents of the suspension.

It can be advantageous to use at least one oxide particle fraction whose particles have an average particle size of from 0.1 to 10 μm, preferably from 0.5 to 5 μm and particularly preferably from 1 to 3 μm. As oxide particles for producing the suspension, particular preference is given to using aluminium oxide particles which preferably have an average particle size of from 0.5 to 10 μm, preferably from 1 to 4 μm.

Aluminium oxide particles in the range of the preferred particle sizes are marketed, for example, by Martinswerke under the trade names MZS 3 and MZS 1 and by AlCoA under the trade names CT3000 SG, CL3000 SG. CT1200 SG, CT800SG and HVA SG.

In the process of the invention, the application and introduction of the suspension on the substrate and into the interstices of the substrate can be carried out by, for example, printing, pressing on, pressing in, rolling on, doctor blade application, painting, dipping, spraying or pouring on.

The substrate used preferably has a thickness of less than 30 μm, preferably less than 20 μm and particularly preferably from 10 to 20 μm. Particular preference is given to using substrates as have been described in the description of the separator of the invention. The porous substrate used thus particularly preferably comprises woven or unwoven polymer fibres. Particular preference is given to using a substrate which comprises a woven polymer fabric or polymer nonwoven or is such a woven fabric or nonwoven. The substrate used preferably has polymer fibres which have a softening point of greater than 100° C. and a melting point of greater than 110° C. It can be advantageous for the polymer fibres to have a diameter of from 0.1 to 10 μm, preferably from 1 to 5 μm. Particular preference is given to using a substrate comprising fibres selected from among polyacrylonitrile, polyester, polyamide and polyolefin in the process of the invention.

The suspension used for producing the coating comprises at least particles of Al₂O₃, ZrO₂ and/or SiO₂, at least one fraction of polymer particles and at least one sol, preferably a sol of the elements Al, Zr and/or Si, and is produced by suspending the particles in at least one of these sols. Suspension can be effected by intensive mixing of the components.

It has been found that the use of commercial oxide particles sometimes leads to unsatisfactory results since a very broad particle size distribution is frequently present. Preference is therefore given to using metal oxide particles which have been classified by means of a conventional method such as air classification and hydroclassification. Preference is given to using fractions of oxide particles in which the coarse particle fraction which amounts up to 10% of the total amount has been separated off by wet sieving. This undesirable coarse particle fraction which can be broken up only with great difficulty, if at all, by the methods typical in the production of the suspension, e.g. milling (ball mill, attritor mill, mortar mill), dispersing (Ultra-Turrax, ultrasound), trituration or chopping, can consist, for example, of aggregates, hard agglomerates, abraded material from milling media. As a result of the abovementioned measures, the electrically nonconductive coating has a very uniform pore size distribution.

Table 1 below gives an overview of the effect of the choice of various aluminium oxides on the porosity and the resulting pore size of the respective porous inorganic coating. To determine these data, the respective slips (suspensions or dispersions) were produced and dried and solidified as pure shaped bodies at 200° C.

TABLE 1
Typical data of ceramics as a function of the type of powder used

| | | Average pore |
|---|---|---|
| Al₂O₃ grade | Porosity in % | size in nm |
| AlCoA CL3000SG | 51 | 755 |
| AlCoA CT800SG | 53.1 | 820 |
| AlCoA HVA SG | 53.3 | 865 |
| AlCoA CL4400FG | 44.8 | 1015 |
| Martinsw. DN 206 | 42.9 | 1025 |
| Martinsw. MDS 6 | 40.8 | 605 |
| Martinsw. MZS 1 + Martinsw. | 47 | 445 |
| MZS 3 = 1:1 | | |
| Martinsw. MZS 3 | 48 | 690 |

For the purposes of the present invention, the average pore size and the porosity are the average pore size and porosity, respectively, which can be determined by the known method of mercury porosimetry, e.g. using a Porosimeter 4000 from Carlo Erba Instruments. Mercury porosimetry is based on the Washburn equation (E. W. Washburn, “Note on a Method of Determining the Distribution of Pore Sizes in a Porous Material”, Proc. Natl. Acad. Sci., 7, 115-16 (1921)).

In the suspension used, the proportion by mass of the suspended components (i.e. the particles) is preferably in the range from 10 to 80%, particularly preferably from 30 to 70%.

The sols can be obtained by hydrolysis of at least one (precursor) compound of the elements Zr, Al and/or Si. It can be advantageous to add the compound to be hydrolysed to alcohol or an acid or a combination of these liquids before the hydrolysis. As compound to be hydrolysed, preference is given to hydrolysing at least one nitrate, chloride, carbonate or alkoxide compound of the elements Zr, Al and/or Si. The hydrolysis is preferably carried out in the presence of water, water vapour, ice, alcohol or an acid or a combination of these compounds. The sols are preferably obtained by hydrolysing a compound of the elements Al, Zr or Si by means of water or an acid diluted with water, where the compounds are preferably present as a solution in a nonaqueous, optionally water-free solvent and are hydrolysed by means of from 0.1 to 100 times the molar amount of water.

In one variant of the process for producing the separator of the invention, particulate sols are produced by hydrolysis of the compounds to be hydrolysed. In these particulate sols, the compounds formed in the sol by hydrolysis are present in particulate form. These particulate sols can be produced as described above, as in WO 99/15262, or as in WO 2007/028662. These sols usually have a very high water content which is preferably greater than 50% by weight. It can be advantageous to add the compound to be hydrolysed to alcohol or an acid or a combination of these liquids before the hydrolysis.

The wetting behaviour of the sol or the suspension is preferably matched in the process of the invention. This matching is preferably effected in the production of polymeric sols or suspensions of polymeric sols, where these sols comprise one or more alcohols such as methanol, ethanol or propanol or mixtures thereof. However, other solvent mixtures which can be added to the sol or the suspension in order to match the wetting behaviour of this to the nonwoven used are also conceivable.

It has been found that the fundamental alteration of the sol system and the suspension resulting therefrom leads to a significant improvement in the adhesion properties of the ceramic components on and in a polymeric nonwoven material. Preference is also given to coating nonwovens comprising polymer fibres by means of suspensions which have, in a preceding step, been provided with a bonding agent by treatment with a polymeric sol.

In a further variant of the process for producing a separator which can be used according to the invention, polymeric sols are produced by hydrolysis of the compounds to be hydrolysed. In these polymeric sols, the compounds formed in the sol by hydrolysis are present in polymeric form (i.e. crosslinked in a chain-like fashion over a relatively large volume). The polymeric sols usually comprise less than 50% by weight, preferably very much less than 20% by weight, of water and/or aqueous acid. To arrive at the preferred proportion of water and/or aqueous acid, the hydrolysis is preferably carried out by hydrolysing the compound to be hydrolysed by means of from 0.5 to 10 times the molar amount and preferably by means of half the molar amount of water, water vapour or ice, based on the hydrolysable group of the hydrolysable compound. An up to 10-fold amount of water can be used in the case of compounds which hydrolyse very slowly, e.g. in the case of tetraethoxysilane. Compounds which hydrolyse very quickly, for example zirconium tetraethoxide, can readily form particulate sols under these conditions and a 0.5-fold amount of water is therefore preferably used for the hydrolysis of such compounds. Hydrolysis using less than the preferred amount of water, water vapour or ice likewise leads to good results. However, use of an amount which is more than 50% less than the preferred amount of half the molar amount is not very useful since in the case of amounts lower than this value the hydrolysis is no longer complete and coatings based on such sols are not very stable.

To produce these sols having the desired very small proportion of water and/or acid in the sol, it can be advantageous to dissolve the compound to be hydrolysed in an organic solvent, in particular ethanol, isopropanol, butanol, amyl alcohol, hexane, cyclohexane, ethyl acetate and/or mixtures of these compounds, before the actual hydrolysis is carried out. A sol produced in this way can be used for producing the suspension according to the invention or as bonding agent in a pretreatment step. Particular preference is given to using a suspension comprising a polymeric sol of a compound of silicon for producing the separator of the invention.

Both the particulate sols and the polymeric sols can be used as sol in the process of the invention for producing the suspension. Apart from the sols which can be obtained as just described, it is in principle also possible to use commercial sols such as zirconium nitrate sol or silica sol.

To improve the adhesion of the organic compounds to polymer fibres or nonwovens as substrate and also to improve the adhesion of any shutdown layer to be applied later, it can be advantageous to add bonding agents, e.g. organofunctional silanes such as the Evonik silanes GLYMO, GLYEO, MEMO, AMEO, VTEO or Silfin to the suspensions used. The addition of bonding agents is preferred in the case of suspensions based on polymeric sols. As bonding agents, it is possible to use, in particular, compounds selected from among octylsilanes, vinylsilanes, amino-functionalized silanes and glycidyl-functionalized silanes, e.g. the Dynasilans from Evonik. Particularly preferred bonding agents for polyethylene (PE) and polypropylene (PP) are vinylsilanes, methylsilanes and octylsilanes, with exclusive use of methylsilanes not being optimal. The bonding agents have to be selected so that the solidification temperature is below the melting or softening point of the polymers used as substrate and below the decomposition temperature thereof. As bonding agents, it is possible to use, in particular, the silanes shown in Table 2. Suspensions according to the invention preferably comprise very much less than 25% by weight, preferably less than 10% by weight, of compounds which can function as bonding agents.

TABLE 2

| Polymer | Organo function type | Bonding agent |
|---|---|---|
| PAN | glycidyl | GLYMO |
| | methacryl | MEMO |
| PA | amino | AMEO, DAMO |
| PET | methacryl | MEMO |
| | vinyl | VTMO, VTEO, VTMOEO |
| PE, PP | amino | AMEO, AMMO |
| | vinyl | VTMO, VTEO, Silfin |
| | methacryl | MEMO |

### Here:

AMEO=3-aminopropyltriethoxysilane
DAMO=2-aminoethyl-3-aminopropyltrimethoxysilane
GLYMO=3-glycidyloxypropyltrimethoxysilane
GLYEO=3-glycidyloxypropyltriethoxysilane
MEMO=3-methacryloxypropyltrimethoxysilane
Silfin=vinylsilane+initiator+catalyst
VTEO=vinyltriethoxysilane
VTMO=vinyltrimethoxysilane
VTMOEO=vinyltris(2-methoxyethoxy)silane

The suspension present on the substrate and in the interstices of the substrate as a result of the application and introduction can, for example, be solidified by heating to from 50 to 350° C. Since the maximum temperature is predetermined by the substrate material when polymeric substrate materials are used, this temperature has to be selected appropriately so that the substrate material does not melt or soften. Thus, depending on the variants of the process, the suspension present on and in the substrate is preferably solidified by heating to from 100 to 350° C. and very particularly preferably by heating to from 200 to 280° C. The heating of the suspension on a polymer nonwoven composed of polyester fibres is preferably carried out for from 0.2 to 10 minutes at a temperature of from 200 to 220° C. The heating of the suspension on a polymer nonwoven composed of polyamide fibres is preferably carried out for from 0.5 to 10 minutes at a temperature of from 170 to 200° C. Heating of the composite can be effected by means of heated air, hot air, infrared radiation or other heating methods according to the prior art.

The process for producing separators which can be used in the process of the invention can, for example, be carried out by rolling the substrate off from a roll at a velocity of from 1 m/h to 2 m/s, preferably at a velocity of from 0.5 m/m in to 20 m/min, by means of at least one apparatus which applies the suspension on and in the substrate, e.g. a roller, and runs through at least one further apparatus which allows solidification of the suspension on and in the substrate by heating, e.g. an electrically heated oven, and the separator produced in this way is rolled up on a second roll. In this way, it is possible to produce the separator in a continuous process. The pretreatment steps can also be carried out in a continuous process, adhering to the abovementioned parameters.

The separators of the invention or the separators produced according to the invention can be used as separator in batteries, in particular as separator in lithium ion batteries, preferably high-performance lithium batteries and high-energy lithium batteries. Such lithium batteries can have lithium salts having large anions in carbonates as solvent as electrolytes. Suitable lithium salts are, for example, LiClO₄, LiBF₄, LiAsF₆ or LiPF₆, with LiPF₆ being particularly preferred. Organic carbonates suitable as solvents are, for example, ethylene carbonate, propylene carbonate, dimethyl carbonate, ethyl methyl carbonate or diethyl carbonate or mixtures thereof.

Lithium ion batteries which have a separator according to the invention can be used, in particular, in vehicles which are electrically driven or have a hybrid drive technology, e.g. electric cars or hybrid cars.

### COMPARATIVE EXAMPLE

### Separator According to the Prior Art

30 g of a 5% by weight aqueous HNO₃ solution, 10 g of tetraethoxysilane, 10 g of Dynasilan AMEO and 10 g of Dynasilan GLYMO (all silanes from Evonik Degussa GmbH) were firstly added to 130 g of water and 15 g of ethanol. 125 g of each of the aluminium oxides Martoxid MZS-1 and Martoxid MZS-3 (both oxides from Martinswerk) were then suspended in this sol which had firstly been stirred for a few hours. This slip was homogenized by means of a magnetic stirrer for at least a further 24 hours, with the stirring vessel having to be covered so that a loss of solvent did not occur.

A 20 cm wide PET nonwoven (Freudenberg Vliesstoffe KG) having a thickness of about 20 μm and a weight per unit area of about 10 g/m² was then coated with the above slip in a continuous rolling-on process (strip velocity about 30 m/h, T=200° C.). A separator having an average pore width of 240 nm was obtained at the end.

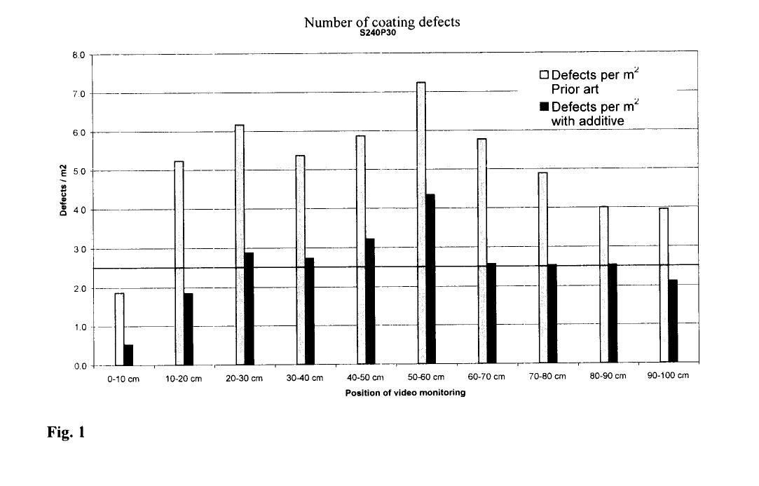

The number of defects in the coating per square metre of the separator was subsequently determined by means of a video monitoring system from ISRA. FIG. 1 shows this number in grey bars as a function of the position of the video camera, measured in the width of the separator strip in a range of from 0 to 100 cm width in sections of in each case 10 cm. The average number of defects calculated via the position of the video monitoring was about 5 per m² of separator area.

The usability of the ceramic composite produced as indicated was examined by construction of an electrochemical cell in the form of a lithium ion flat battery. The battery comprised a positive composition (LiCoO₂), a negative composition (graphite) and an electrolyte composed of 1 mol/l of LiPF₆ in ethylene carbonate/dimethyl carbonate (weight ratio 1:1). To produce the electrodes, positive composition (3% of carbon black (from Timcal, Super P), 3% of PVdF (from Arkema, Kynar 761), 50% of N-methylpyrrolidone) or negative composition (1% of carbon black (from Timcal, Super P), 4% of PVdF (from Arkema, Kynar 761), 50% of methylpyrrolidone) is applied by means of a doctor blade in a layer thickness of 100 μm to aluminium foil (from Tokai, 20 μm) or copper foil (from Microhard, 15 μm), respectively, and dried to constant weight at 110° C. The ceramic composite material according to the prior art or according to the example indicated below was used as separator between the electrodes of the battery. The battery in each case operated stably over more than 550 cycles.

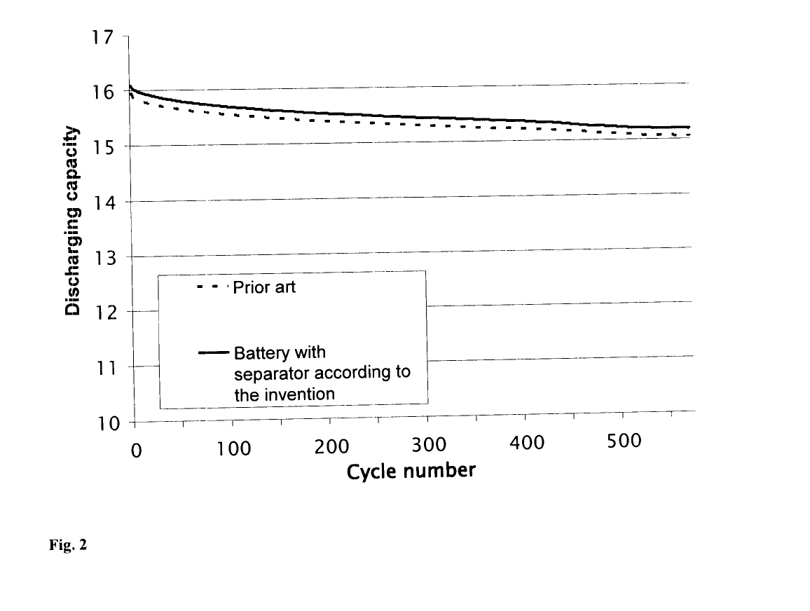

The discharging capacity of this cell was subsequently measured as a function of the cycle number. The corresponding curve is shown as the broken line in FIG. 2.

### Example

### Separator with Additive

A suspension was made up as in the comparative example. However, 2% by weight of beta-cyclodextrin as additive was stirred into the slip obtained. This slip was homogenized for a further 24 hours by means of a magnetic stirrer, with the stirring vessel having to be covered so that a loss of solvent did not occur.

A 20 cm wide PET nonwoven (Freudenberg Vliesstoffe KG) having a thickness of about 20 μm and a weight per unit area of about 10 g/m² was then coated with the above slip in a continuous rolling-on process (strip velocity about 30 m/h, T=200° C.). A separator having an average pore width of 240 nm was obtained at the end.

The number of defects in the coating per square metre of the separator surface determined by means of the video monitoring system is shown as black bars in FIG. 1. The number of defects in the coating of the separator according to the invention is significantly reduced by the additive in all positions of the video monitoring and the calculated average number of defects per m² of separator area was reduced by about half compared to the value for the separator according to the prior art.

The separator according to the invention was installed in an electrochemical cell whose structure was the same as in the comparative example with the exception of the separator. The discharging capacity in mAh is shown as a function of the cycle number as the solid line in FIG. 2.

1. A separator comprising a porous coating which is not electrically conductive,
wherein
the coating of comprises oxide particles which are adhesively bonded to one another and to a substrate by means of an inorganic adhesive,
the oxide particles comprise at least one oxide selected from the group consisting of Al₂O₃ and SiO₂ on a substrate and in interstices of the substrate which has fibres comprising a material which is not electrically conductive,
the coating is a ceramic coating, and
a sugar is present in the ceramic coating.

2. The separator according to claim 1, wherein a side has a number of defects of not more than 4.5 per m².

3. The separator according to claim 1, wherein the sugar is a cyclic sugar which has from 6 to 8 glucose units.

4. A process for producing a separator according to claim 1, comprising
coating a substrate with a ceramic coating, wherein the substrate comprises fibres of a material which is not electrically conductive and has interstices between the fibres by applying a suspension on and in the substrate and solidifying the suspension on and in the substrate by heating at least once,
wherein the suspension comprises
a sol comprising oxide particles selected from oxides of elements Al and Si dispersed in the sol,
a silane,
a dispersion medium and
a sugar.

5. The process according to claim 4,
wherein the sugar is
a cyclic sugar, an acylic sugar,
or a mixture thereof.

6. The separator according to claim 1, wherein the separator is suitable for batteries.

7. A lithium ion battery comprising a separator according to claim 1.

8. A traction system comprising a lithium ion battery according to claim 7.

9. The separator according to claim 1, wherein the sugar is a cyclodextrin.

10. The process according to claim 5, wherein the sugar has from 6 to 8 glucose units.

11. The process according to claim 10, wherein the sugar is a cyclodextrin.
